(19) United States
(12) Patent Application Publication
(10) Pub. No.: US 2007/0017622 A1
(43) Pub. Date: Jan. 25, 2007

(54) Apparatus for making cloth articles of manufacturing and the like

(75) Inventor: Giovanni Cartabbia, Palazzo SullOglio (Brescia) (IT)

Correspondence Address: HEDMAN & COSTIGAN P.C., 1185 AVENUE OF THE AMERICAS, NEW YORK, NY, 10036, US

(73) Assignee: MACPI - PRESSING DIVISION S.p.A.

(21) Appl. No.: 11/435,501

(22) Filed: May 17, 2006

(30) Foreign Application Priority Data
Jul. 25, 2005 (IT) MI2005A 001435

(51) Int. Cl. B31B 1/60

(52) U.S. Cl. 156/60

(57) ABSTRACT

An apparatus for making cloth articles of manufacture and the like comprises a bearing framework including a working or processing region, where a fabric tubular element is arranged, and comprising cutting means for cutting said tubular element, said cutting means being adapted to provide a cut-through edge and hemming means for applying an adhesive strip to the cut through edge.

### BACKGROUND OF THE INVENTION

The present invention relates to an apparatus for making cloth articles of manufacture and the like.

More specifically, the present invention relates to an electromechanic apparatus designed for cutting to a desired shape and simultaneously hemming, by an adhesive textile applied element, a fabric material tubular element.

Is already known in the prior art to make knitted articles of manufacture starting from a tubular knitted element which is cut and hemmed by applying an adhesive fabric strip thereto.

Conventional cutting and hemming operations on said tubular element were performed as separate operating steps, either manually or by a machine for applying an adhesive strip to the tubular element.

### SUMMARY OF THE INVENTION

The aim of the present invention is to provide such an apparatus which allows to make the desired cloth or fabric articles of manufacture in a much more quick and efficient manner than prior like articles of manufacture making systems.

Within the scope of the above mentioned aim, a main object of the invention is to provide such an apparatus which is adapted to cut and hem a tubular element by substantially simultaneous cutting and hemming operations.

Another object of the present invention is to provide such an apparatus allowing to finishing the fabric material edge, independently from its type, without using seaming operations.

Another object of the present invention is to provide such an apparatus allowing the articles of manufacture to be finished without altering the resilient characteristics of their fabric materials and additional applied materials.

Yet another object of the present invention is to provide such an apparatus allowing to carry out finishing operations on said articles of manufacture by means of hemming, edging and flat application operations, to allow a textile fabric material to always contact the skin of a user, that is preventing the user skin from being contacted by a plastics material.

Yet another object of the present invention is to provide such an apparatus for making cloth articles of manufacture and the like which, owing to its specifically designed features, is reliable and safe in operation.

According to one aspect of the present invention, the above mentioned aim and objects, as well as yet other objects, which will become more apparent hereinafter, are achieved by an apparatus for making cloth articles of manufacture and the like, characterized in that said apparatus comprises a bearing framework defining a working region where a fabric material tubular element is arranged, and comprising cutting means for cutting said tubular element to provide said tubular element with a cut through edge, and hemming means for applying an adhesive strip to said cut edge of said tubular element.

### BRIEF DESCRIPTION OF THE DRAWINGS

Further characteristics and advantages of the present invention will become more apparent hereinafter from the following detailed disclosure of a preferred, though not exclusive, embodiment of the invention which is illustrated, by way of an indicative, but not limitative, example in the accompanying drawings, where:

FIG. 1 is a schematic side elevation view, in cross-section, showing an apparatus according to the present invention;

FIG. 2 is a perspective view, on an enlarged scale, showing the working region of the apparatus;

FIG. 3 is a side elevation view, schematically showing cutting means and hemming means included in the apparatus according to the invention; and

FIG. 4 is a further schematic perspective view showing in a more detailed manner the hemming means included in the apparatus according to the invention.

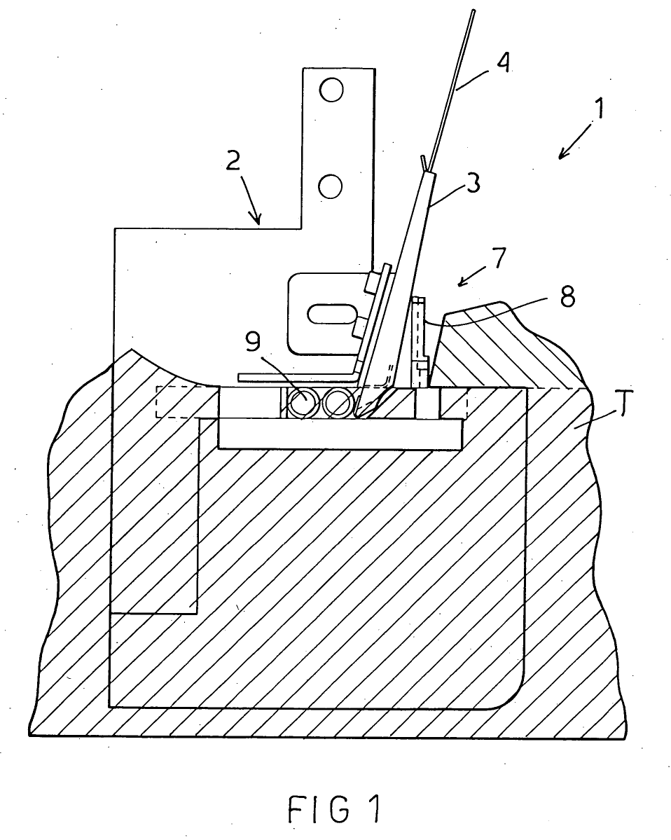

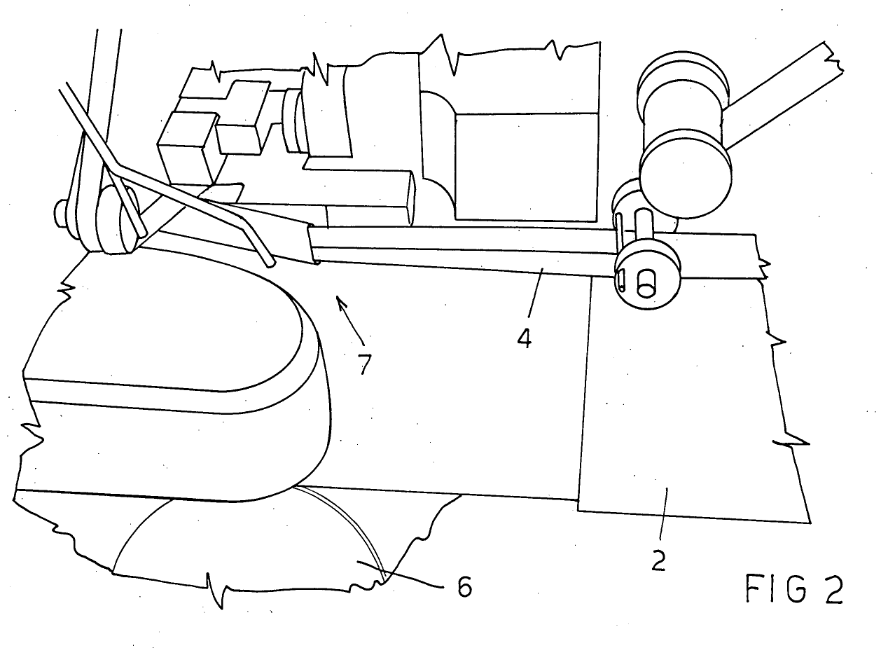

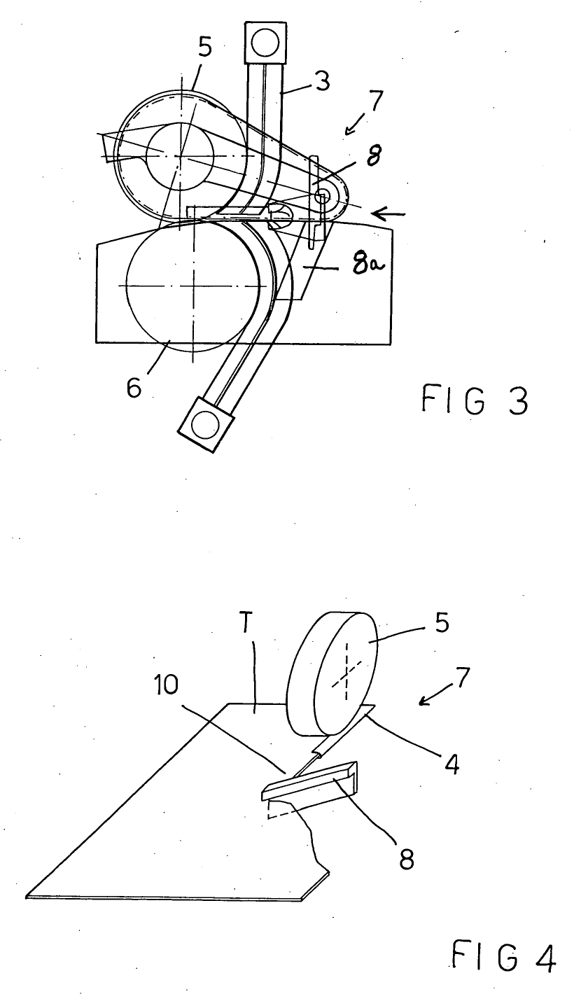

### DESCRIPTION OF THE PREFERRED EMBODIMENTS

With reference to the number references of the above mentioned figures, the apparatus according to the invention, which has been generally indicated by the reference number 1, comprises a bearing framework 2, thereon a working region 7 is defined, said working region comprising a fabric material hemming means, including a guide element 3 for an adhesive strip, generally indicated by the reference number 4, which adhesive strip is delivered or fed, by a strip feeding assembly, from an adhesive strip delivery bobbin or roll.

The hemming device proper 3 is arranged, with an outlet end thereof, at a top wheel 5 and a bottom wheel 6, therebetween a textile fabric material, generally indicated by the letter T, which must be performed to finishing steps, is caused to pass.

More specifically, said wheels 5 and 6 are coupled through driving motors.

According to the present invention, the working region 7, comprises, upstream of the hemming means, cutting means comprising at least two cutting blades or knives 8 and 8a, designed for cutting through the textile fabric material T according to a preset cutting plane.

To that end, the fabric material T comprises suitable marking means for marking a cutting line, designed for allowing an operator to guide said fabric material to allow the cutting blade 8 to follow the preset cutting line.

The above disclosed apparatus or machine can carry out several types of operating steps.

In particular, the apparatus is adapted to perform a hemming operation, by using a strip which can comprise a single-adhesive fabric strip 4 to be folded to provide a sort of bridge of the fabric material T, thereby correspondingly cover the edge portions, as is clearly shown in FIG. 4.

The hemming operation can also be performed by a single-adhesive casing tape element.

For performing the hemming operation, the fabric material T is folded at an edge portion thereof and is supplied a strip including a biadhesive film or a biadhesive resilient element.

For flatly applying the strip, it is possible to apply to the textile fabric material T a monoadhesive film or, optionally, a monoadhesive fabric.

To provide a proper heating, the apparatus further comprises a heating region 10 including heating means 9.

It has been found that the invention fully achieves the above mentioned aim and objects.

In fact, the invention provides an electropneumatic apparatus for cutting to a desired shape and simultaneously hem the cut fabric material by using an adhesive textile auxiliary strip element.

The apparatus according to the present invention is also designed for performing cutting and hemming operations on fabric pieces made on a circular seamless loom.

The apparatus, moreover, comprises adjusting means for adjusting the height of the processing plane thereof, and the working station can be slanted according to any desired inclination.

Moreover, the apparatus further comprises a fitting drawer, a driving system and two wheels which are actuated or driven with independent speeds (a differential effect) by a sequential change gear, and a trimming device for trimming away the exceeding fabric portion before the hemming operation proper: moreover, the subject apparatus also provides to perform a variable frequency cutting operation.

Moreover, the bottom and top heating devices for heating the adhesive material provide independent adjustments of the adhesive melting temperature.

The heat amount can be automatically changed depending on the fabric material feeding speed.

Moreover, the apparatus can also comprise cooling means for properly cooling the outlet adhesived edge of the fabric.

The top wheel can swing with an adjustable pressure and an electronic apparatus is furthermore provided for controlling and sequentially programming the tension of the elastic elements.

Furthermore, the apparatus comprises a programmable logic programming device which can be coupled to the system network to receive and transmit data in real time, as well as illuminating means for illuminating the bottom of the cutting region, suction means for sucking away the waste materials, and further control and programming means for controlling the adhesive strip feeding devices.

The adhesive material applied to the adhesive strip can comprise either one or more continuous adhesive layers or can be applied according to a point by point pattern, thereby providing a grid-like adhesive pattern.

Finally, the apparatus according to the present invention is designed for receiving a broad range of fittings for performing a lot of different types of processing operations.

In practicing the invention, the used materials, as well as the contingent size and shapes can be any, according to requirements and the status of the art.

1. An apparatus for making cloth articles of manufacture and the like, characterized in that said apparatus comprises a bearing framework defining a working region where a fabric material tubular element is arranged, and comprising cutting means for cutting said tubular element to provide said tubular element with a cut through edge, and hemming means for applying an adhesive strip to said cut edge of said tubular element.

2. An apparatus, according to claim 1, characterized in that said hemming means comprise a guide element for an adhesive strip, which is supplied, through an adhesive strip feeding assembly, by an adhesive strip delivery apparatus.

3. An apparatus, according to claim 2, characterized in that said guide element has an outlet end portion arranged at a top wheel and a bottom wheel, said fabric material to be finished being caused to pass between said top wheel and bottom wheel.

4. An apparatus, according to claim 3, characterized in that said top and bottom wheels are coupled by driving motors.

5. An apparatus, according to claim 1, characterized in that said cutting means comprises at least a pair of cutting blades designed for cutting the fabric material according to a preset cutting plane.

6. An apparatus, according to claim 1, characterized in that said fabric material is provided with marking means for marking a cutting line on said fabric material, thereby allowing an operator to guide said fabric material to allow said cutting blade to follow a preset cutting line.

7. An apparatus, according to claim 1, characterized in that said apparatus is designed for performing said hemming operation by using a strip comprising a monoadhesive fabric material, to be folded to bridge the fabric material thereby covering corresponding edge portions thereof.

8. An apparatus, according to claim 1, characterized in that said hemming is carried out by using a monoadhesive casing tape element.

9. An apparatus, according to claim 1, characterized in that, as said apparatus is used for performing said hemming, said fabric material is folded at an edge portion thereof, and being provided with a strip including a biadhesive film or a biadhesive resilient element.

10. An apparatus, according to claim 1, characterized in that as said apparatus performs a finishing operation by flatly applying said strip, said fabric material is provided with a monoadhesive film or, optionally, a monoadhesive fabric.

11. An apparatus, according to claim 1, characterized in that said apparatus further comprises heating means for heating an adhesive strip application region.

12. An apparatus, according to claim 11, characterized in that the adhesive can be applied at one or more strips or in the form of a point by point grid pattern.

13. An apparatus, according to claim 1, characterized in that said apparatus is also adapted to cut and hem fabric pieces made on a circular seamless loom.

14. An apparatus, according to claim 1, characterized in that said apparatus further comprises adjusting means for adjusting an height of a working plane thereof and for slanting a working station thereof.

15. An apparatus, according to claim 1, characterized in that said apparatus comprises moreover a drawer assembly for holding a plurality of working fittings.

16. An apparatus, according to claim 1, characterized in that said apparatus further comprises motor means for driving with independent driving speeds said wheels, thereby providing a differential type of action with a sequential change.

17. An apparatus, according to claim 1, characterized in that said apparatus further comprises a trimming device for trimming away an exceeding fabric portion before performing the hemming operation, with an adjustment of the cutting frequency.

18. An apparatus, according to claim 1, characterized in that said apparatus comprises moreover heating adjusting means for automatically adjusting an amount of heat depending on the fabric material advancing or feeding speed, cooling means for cooling the adhesived edge being moreover provided at an outlet of said apparatus.

19. An apparatus, according to claim 1, characterized in that said top wheel can swing with an adjustable pressure, an electronic apparatus being moreover provided for electronically controlling and sequentially programming a tension on resilient means of said apparatus.

20. An apparatus, according to claim 19, characterized in that said electronic apparatus comprises an electronic programmable logic programming device adapted to be coupled to the system network and to transmit and receive operating data in a real time.

21. An apparatus, according to claim 1, characterized in that said apparatus further comprises illuminating means arranged at a bottom of a cutting region of said apparatus.
